(19) United States
(12) Patent Application Publication
(10) Pub. No.: US 2013/0326212 A1
(43) Pub. Date: Dec. 5, 2013

(54) HELPER APPLICATIONS FOR DATA TRANSFERS OVER SECURE DATA CONNECTIONS

(71) Applicants: Jason Schultz, Plymouth, MN (US); James Heit, Vadnais Heights, MN (US); Robert Bergerson, Blaine, MN (US)

(72) Inventors: Jason Schultz, Plymouth, MN (US); James Heit, Vadnais Heights, MN (US); Robert Bergerson, Blaine, MN (US)

(21) Appl. No.: 13/486,178

(22) Filed: Jun. 1, 2012

(51) Int. Cl. H04L 29/06

(52) U.S. Cl. CPC H04L 63/126
USPC 713/152

(57) ABSTRACT

Data rates in secure data communications may be improved by executing helper applications to assist a computer system in responding to requests for secure data. The computation-intensive calculations may be offloaded to helper applications executing on different central processor units (CPUs). When the helper applications execute on different CPUs, higher data rates are achievable because additional CPU time is available for handling the encryption and decryption processing. A main application receives the initial request for secure data connections and assigns tasks related to the connections to the helper applications.

The instant disclosure relates to data communications. More specifically, this disclosure relates to improving performance of secure data transfers.

### BACKGROUND

Secure data transfers consume significant amount of processing power. In particular, methods for encrypting data and the algorithms implemented for encrypting the data have become significantly more complex as demand for security has increased. Additionally, the amount of data transfers that are encrypted has increased. For example, shopping and financial transactions, and even electronic mail, are delivered through secure data connections.

FIG. 1 is block diagram illustrating a conventional system for handling secure data transfers. A computer system 110 stores data 112 and executes an encryption application 114. The computer system 110 is connected to a network 120 for transferring data, including secure data. The encryption application 114 loads the data 112 and encrypts the data 112 to form secure data 116. The computer system 110 then transfers the secure data 116 to the network 120.

The conventional design for an encryption application places all data handling in a single application or thread. However, relying on a single application or thread can limit performance of a computer system. Because each thread executes on only one processor and the secure data transfers consume significant processing power, a single thread can be overwhelmed with the quantity of data processing when multiple secure data transfers co-exist. Further, when a processor is running at maximum capacity, any additional secure connections share the processor with the existing connections. Thus, each additional secure data transfer further reduces the transfer rate of all previously-established secure data connections.

### SUMMARY

According to one embodiment, a method includes receiving, at an application, a request for a secure transfer of data. The method also includes assigning a task related to the secure transfer to a helper application. The method further includes transferring the data after the helper application has completed the task.

According to another embodiment, a computer program product includes a non-transitory computer readable medium having code to receive, at an application, a request for a secure transfer of data. The medium also includes code to assign a task related to the secure transfer to a helper application. The medium further includes code to transfer the data after the helper application has completed the task.

According to a further embodiment, an apparatus includes a memory and a processor coupled to the memory. The processor is configured to receive, at an application, a request for a secure transfer of data. The processor is also configured to assign a task related to the secure transfer to a helper application. The processor is further configured to transfer the data after the helper application has completed the task.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is block diagram illustrating a conventional system for handling secure data transfers.

FIG. 2 is a block diagram illustrating an exemplary system for handling secure data transfers according to one embodiment of the disclosure.

FIG. 3 is a flow chart illustrating one method for handling secure data transfers according to one embodiment of the disclosure.

FIG. 4 is a block diagram illustrating a queue system for assigning secure data connections to helper applications according to one embodiment of the disclosure.

FIG. 5 is block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosing an emulated hardware environment according to one embodiment of the disclosure.

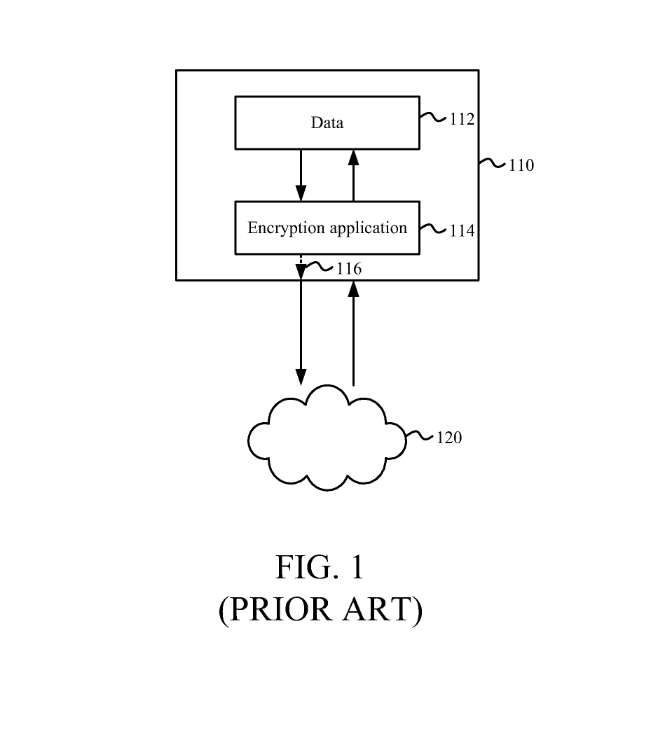

### DETAILED DESCRIPTION

Data transfer rates for secure data communications in a computer system may be improved by transferring certain data processing tasks to helper applications. The helper applications may be assigned to different processors, such that multiple secure data transfers may be completed with a reduced burden on each processor in the computer system. According to one embodiment, the helper applications may decrypt data, remove and verify media access control (MAC) addresses, remove secure socket layer/transport layer security (SSL/TLS) headers, add SSL/TLS headers, calculate and add MAC addresses, and/or encrypt data. The helper applications may also perform other computation intensive calculations, although the helper applications are not limited to performing only such calculations.

The helper applications may be designed to assist a main application. The main application may handle actions not performed by a helper, such as opening and closing connections and other connection management processing. The main application may assign tasks to one or more helper activities, based, in part, on the number of secure data connections.

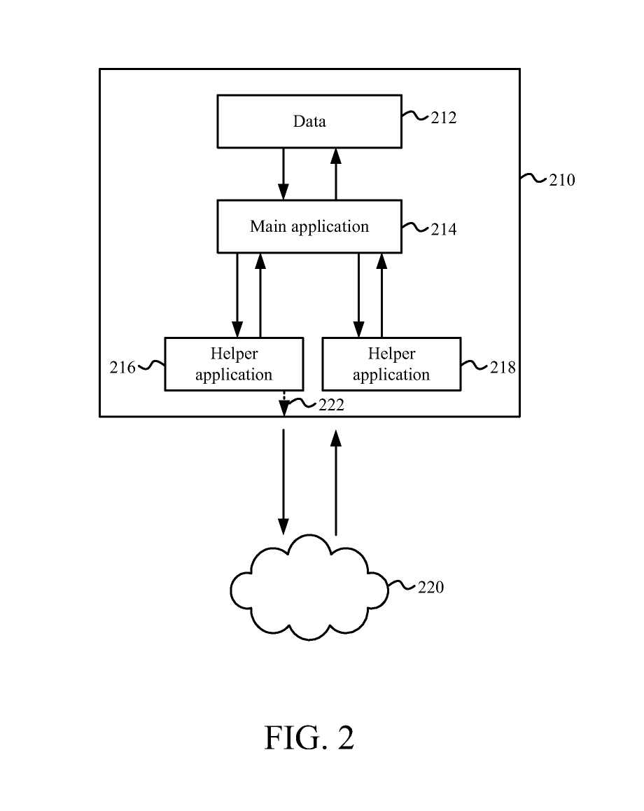

FIG. 2 is a block diagram illustrating an exemplary system for handling secure data transfers according to one embodiment of the disclosure. A computer system 210 stores data 212, such as in memory or on a computer-readable storage device. The computer system 210 may also execute a main application 214 for handling data communications. Further, the computer 210 may execute helper applications 216 and 218. Although only two helper applications are illustrated, fewer or additional helper applications may execute on the computer 210. For example, the computer 210 may execute up to 16 or 32 helper applications. Further, helper applications may execute on other computer systems, but communicate with the main application 214 on the computer 210. The helper applications 216 and 218 communicate with the main application 214. For example, the helper applications 216 and 218 may receive tasks for completion by the helper applications 216 and 218. In another example, the helper applications 216 and 218 may communicate processed data back to the main application 214.

The helper applications 216 and 218 may be assigned to individual central processing units (CPUs) within the computer 210. For example, the computer 210 may have 8 CPUs with hyperthreading capability allowing execution of two applications on each processor. Each of 16 helper applications on the computer 210 may be assigned to individual threads of the processors. In the event more helper applications are executing than number of CPUs available, the helper applications may share CPUs. Helper applications may also have access to specialized hardware within the computer 210, such as data encryption processors. According to one embodiment, helper applications may be designed to execute on high security modules (HSMs) within the computer 210.

According to one embodiment, data encryption for an outgoing connection may be tasked to the helper application 216 by the main application 214. The main application 214 may receive a request for the data 212 from a network 220. The main application 214 assigns the helper application 216 to the data connection for transferring data in response to the request. The helper application 216 then reads the data 212, encrypts the data 212 into secure data 222, and transfers the secure data 222 to the network 220.

Other arrangements of the helper applications 216 and 218 with the main application 214 are possible. For example, the helper applications 216 and 218 may communicate only within the computer system 210. Thus, after the helper applications 216 and 218 complete a task, the data may be transferred back to the main application 214, where the data is then transferred to the network 220.

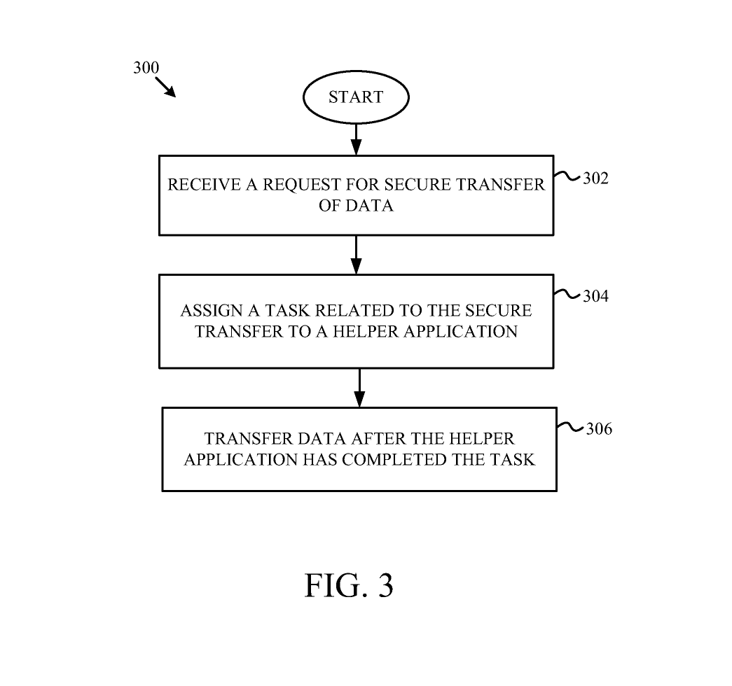

FIG. 3 is a flow chart illustrating one method for handling secure data transfers according to one embodiment of the disclosure. A method 300 begins at block 302 with receiving, at an application, a request for a secure transfer of data. The request may be a connection for sending or receiving data, such as an FTP get or send command. The method 300 continues to block 304 to assign a task related to the secure transfer to a helper application. For example, encryption of the data requested at block 302 may be performed by the helper application. At block 306, the data is transferred to the network after the helper application has completed the task. The secure data may be transmitted by the main application or the helper application.

New secure data connections may be assigned to a particular helper application 216 or 218 of FIG. 2 when the connection is initiated. When the main activity has a task for the helper application 216 or 218 to complete, data is sent to the helper application 216 or 218 that is assigned to the connection associated with the data. By performing all data processing for a secure connection in the same helper application, consistency is maintained. For example, encryption performance may be improved when a connection is secured by cipher block chaining (CBC), such as when block ciphers are repeated, and all tasks for the connection are assigned to the same helper application.

According to one embodiment, connections may be assigned to helper applications by maintaining a count of the number of connections assigned to each helper application. When a new data connection is established the current size of the queue for each helper application is inspected. Then, the data connection is assigned to a helper application based, in part, on the number of connections assigned to the helper applications. For example, the connection may be assigned to the helper application with the fewest connections. However, other methods for assigning connections to helper applications are possible. For example, CPU utilization of the CPU assigned to each helper application may be used as a factor for selecting a helper application.

The connections may also be assigned to helper applications according to a type of connection. When a client computer connects to the computer system through a file transfer protocol (FTP), multiple connections may be established. One connection may be a low volume control connection, and one connection may be a high volume data connection. The control connections may all be assigned to one helper application and the data connections assigned to individual helper applications. In another example, the control connections and the data connections may be evenly distributed between helper applications, such that no helper application is overloaded.

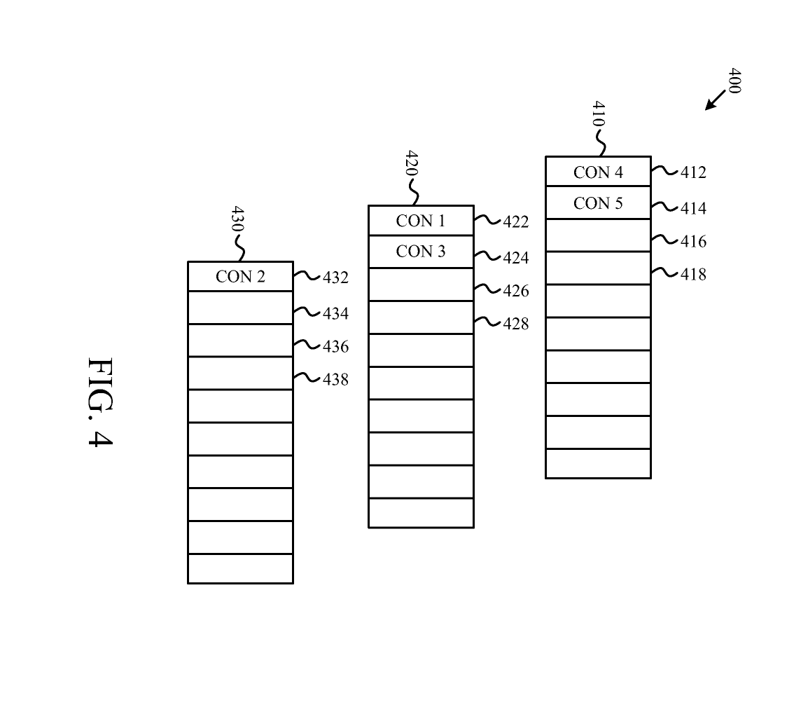

FIG. 4 is a block diagram illustrating a queue system for assigning secure data connections to helper applications according to one embodiment of the disclosure. A queue system 400 includes queues 410, 420, and 430. Each of the queues 410, 420, and 430 includes slots 412-418, 422-428, and 432-438, respectively, for receiving assigned secure data connections. The first queue 410 may include connections not yet assigned to a helper application. These connections may be handled by the main application. When tasks having particular processing tasks, such as encryption and decryption, occur for a data connection, the data connection may be assigned to one of the helper applications. The queues 420 and 430 may include data connections assigned to a first and a second helper application. When selecting a helper application, the queues 420 and 430 are examined and one of the queues 420 or 430 is selected for receiving the data connection. The data connections assigned to the queues 420 and 430 may be recognized by a particular host name receiving the data for the connection, a particular source address for data from the connection, and/or a proprietary identification number tracked by the main application.

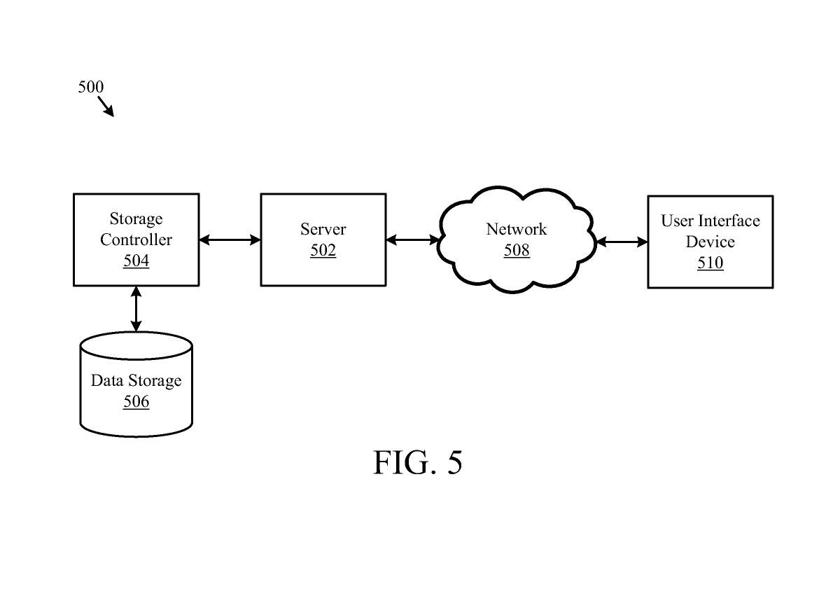

FIG. 5 illustrates one embodiment of a system 500 for an information system, including a system for handling secure data connections as described above. The system 500 may include a server 502, a data storage device 506, a network 508, and a user interface device 510. The server 502 may be a dedicated server or one server in a cloud computing system. The server 502 may also be a hypervisor-based system executing one or more guest partitions. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and provide a user interface for enabling a user to enter or receive information.

The network 508 may facilitate communications of data, such as authentication information, between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS). In this embodiment, the user interface device 510 may be a computer or phone executing a Java application making requests to a JBOSS server executing on a Linux server, which fulfills the requests by accessing a relational database management system (RDMS) on a mainframe server.

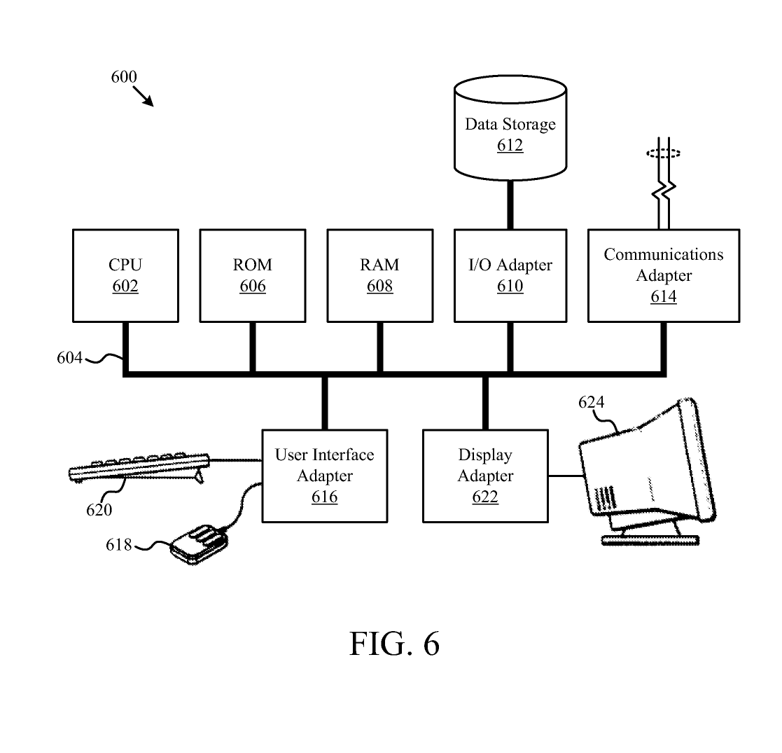

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical, logical, or conceptual.

The applications of the present disclosure are not limited to the architecture of computer system 600. Rather the computer system 600 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

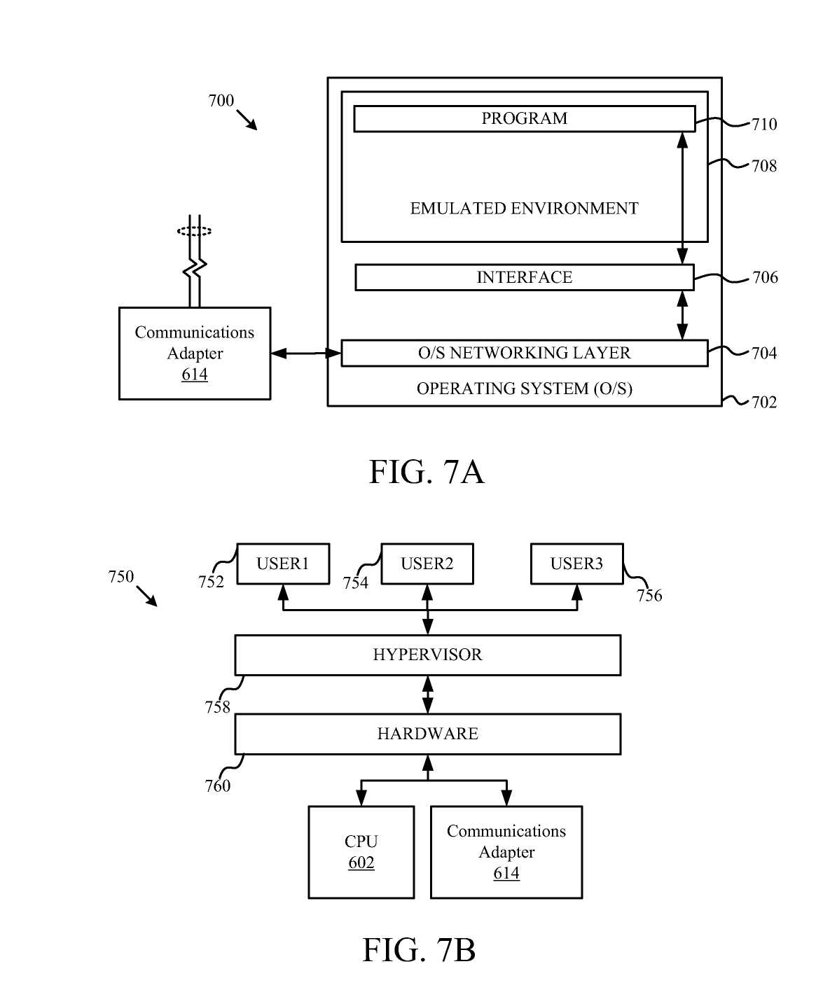

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 614. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosing an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 662 and the communications adaptor 664.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, at an application, a request for a secure transfer of data;
assigning a task related to the secure transfer to a helper application; and
transferring the data after the helper application has completed the task.

2. The method of claim 1, further comprising:
executing the application on a first processor; and
executing the helper application on a second processor different from the first processor.

3. The method of claim 2, further comprising:
receiving, at the application, a request for a second secure transfer of data; and
assigning a task related to the second secure transfer to a second helper application.

4. The method of claim 3, further comprising executing the second helper application on a third processor different from the second processor.

5. The method of claim 4, further comprising:
maintaining a queue of secure transfers; and
assigning the secure transfers from the queue to the first helper application and the second helper application,
in which the queue has a configurable number of helper applications available.

6. The method of claim 1, in which the task is at least one of encrypting the data, decrypting the data, removing and verifying a media access control (MAC) address of the data, removing secure sockets layer/transport layer security (SSL/TLS) headers from the data, adding SSL/TLS headers to the data, and calculating and adding MAC to the data.

7. The method of claim 1, in which the secure transfer of data corresponds to a first connection, and further comprising assigning the helper application to the first connection.

8. A computer program product, comprising:
a non-transitory computer readable medium comprising:
code to receive, at an application, a request for a secure transfer of data;
code to assign a task related to the secure transfer to a helper application; and
code to transfer the data after the helper application has completed the task.

9. The computer program product of claim 8, in which the medium further comprises:
code to execute the application on a first processor; and
code to execute the helper application on a second processor different from the first processor.

10. The computer program product of claim 9, in which the medium further comprises:
code to receive, at the application, a request for a second secure transfer of data; and
code to assign a task related to the second secure transfer to a second helper application.

11. The computer program product of claim 10, in which the medium further comprises code to execute the second helper application on a third processor different from the second processor.

12. The computer program product of claim 11, in which the medium further comprises:
code to maintain a queue of secure transfers; and
code to assign the secure transfers from the queue to the first helper application and the second helper application,
in which the queue has a configurable number of helper applications available.

13. The computer program product of claim 8, in which the task is at least one of encrypting the data, decrypting the data, removing and verifying a media access control (MAC) of the data, removing secure sockets layer/transport layer security (SSL/TLS) headers from the data, adding SSL/TLS headers to the data, and calculating and adding MAC to the data.

14. The computer program product of claim 1, in which the secure transfer of data corresponds to a first connection, and in which the medium further comprises code to assign the helper application to the first connection.

15. An apparatus, comprising:
a memory; and
a processor coupled to the memory, in which the processor is configured:
to receive, at an application, a request for a secure transfer of data;
to assign a task related to the secure transfer to a helper application; and
to transfer the data after the helper application has completed the task.

16. The apparatus of claim 15, in which the processor is further configured:
to execute the application on a first processor; and
to execute the helper application on a second processor different from the first processor.

17. The apparatus of claim 16, in which the processor is further configured:
to receive, at the application, a request for a second secure transfer of data; and
to assign a task related to the second secure transfer to a second helper application.

18. The apparatus of claim 17, in which the processor is further configured to execute the second helper application on a third processor different from the second processor.

19. The apparatus of claim 15, in which the task is at least one of encrypting the data, decrypting the data, removing and verifying a media access control (MAC) of the data, removing secure sockets layer/transport layer security (SSL/TLS) headers from the data, adding SSL/TLS headers to the data, and calculating and adding MAC to the data.

20. The apparatus of claim 15, in which the secure transfer of data corresponds to a first connection, and in which the medium further comprises code to assign the helper application to the first connection.
